(19) United States
(12) Patent Application Publication
(10) Pub. No.: US 2026/0249224 A1
(43) Pub. Date: Aug. 27, 2026

(54) FILTER ELEMENT AND FILTER DEVICE

(71) Applicant: MANN+HUMMEL GmbH, Ludwigsburg (DE)

(72) Inventors: Pascal NEEF, Trossingen (DE); Klaus-Dieter RUHLAND, Meckenheim (DE); Michael KAUFMANN, Meckenheim (DE)

(21) Appl. No.: 19/649,571

(22) Filed: Apr. 16, 2026

Related U.S. Application Data
(63) Continuation of application No. PCT/EP2024/079688, filed on Oct. 21, 2024.

(30) Foreign Application Priority Data
Oct. 23, 2023 (DE) 10 2023 129 023.1

(51) Int. Cl. B01D 46/24; B01D 46/52

(52) U.S. Cl. CPC B01D 46/2403; B01D 46/522; B01D 2201/34; B01D 2275/206

(57) ABSTRACT

A filter element has a filter bellows with a first end and an oppositely positioned second end. A first end plate open toward the interior is arranged at the first end and a second end plate at the second end. A circumferential seal contour at the first end plate rises in longitudinal direction away from the first end plate. The filter bellows has at least one notch at an outer and/or inner circumference. The circumferential seal contour has at least one locally limited protrusion or recess in radial direction arranged such that a circumferential position of the protrusion or recess corresponds to a circumferential position of the notch of the filter bellows. A filter device includes the filter element arranged in a receiving space of a filter housing so that the filter element separates a raw side at a fluid inlet from a clean side at a fluid outlet.

### CROSS REFERENCE TO RELATED APPLICATIONS

This application is a continuation application of international application No. PCT/EP2024/079688 having an international filing date of October 21, 2024, and designating the United States, the international application claiming a priority date of October 23, 2023, based on prior filed German patent application No. 10 2023 129 023.1, the entire contents of the aforesaid applications being incorporated herein by reference to the fullest extent permissible.

### BACKGROUND

The present invention concerns a filter element for filtering a fluid, for example an air filter element for an air filter system, for example for an intake air filter system of a fuel cell or internal combustion engine. Furthermore, the invention concerns a filter device with such a filter element.

The intake air of fuel cells and/or internal combustion engines is usually purified prior to entering a cathode space or combustion chamber by means of an air filter from particulate and/or gaseous contaminants, for which purpose air filter elements are used. Further, the air flowing into a vehicle cabin is nowadays also freed as completely as possible from contaminants. Possibly occurring contaminants are, for example, particulate matter, pollen, soot and aerosols.

In general, filter element or filter insert is understood as device components which, exchangeable as a unit, may be arranged in a filter housing and which include at least one filter medium body of a filter medium, frequently in the form of a folded filter bellows, and usually also a structure carrying or supporting the filter medium, and usually a seal. The respective filter medium usually includes a limited service life for which reason filter elements must be exchanged regularly.

Such filter elements or filter inserts are frequently embodied as so-called round elements which include a filter bellows arranged around a longitudinal axis and enclosing an interior at least partially. The filter bellows may be delimited at a first end face end by an open end plate and at a second end face end opposite the first end face end by a further end plate, for example a closed end plate. Frequently, a circumferential seal is arranged at the open end plate.

For various reasons, it may be technically required in this context that round filter elements are inserted in a predetermined installation position in a filter housing. For example, in the aforementioned applications, volume and/or mass flow sensors are frequently used which measure an intake air quantity. Such volume and/or mass flow sensors are in general calibrated in respect to a certain installation position of the round filter element so that measuring imprecisions occur in case of an installation of the round filter element in the filter housing deviating from the predetermined installation position. The reason for this is that the filter medium body in general has a seam location which affects the flow profile at the outflow side.

WO 2019/219635 A1 discloses a round filter element which includes a circumferentially extending filter bellows which is delimited at its respective ends by an end plate, wherein at least one of the end plates is an open end plate. The filter bellows includes, for example, a star-shaped folded filter medium and includes at its end which is close to the open end plate a spread-apart portion at the outer circumference, wherein the spread-apart portion extends only across a portion of the total length of the filter bellows. The spread-apart portion of the filter bellows is aligned with a corresponding cut at an outer circumference of the open end plate. At the open end plate, a circumferentially extending seal is furthermore arranged which extends in a circular shape radially inwardly of the cut. Furthermore, a filter housing for receiving the round filter element is disclosed therein that in an interior includes a notch which engages in a mounted state the spread-apart portion of the filter bellows of the round filter element in order to position the round filter element in regard to an angular position in relation to the filter housing.

A disadvantage in this context is that the seal contour extends on a comparatively small diameter which is detrimental to an optimal sealing action. Furthermore, the therein proposed system is prone to misuse since any type of filter elements may be installed in the filter housing, for example, after the housing-side notch has been removed.

Moreover, WO 2018/073198 A1 discloses a further filter element that includes a spread-apart portion at an outer circumference of a filter bellows, wherein the filter bellows includes an elongate oval cross-sectional shape. The filter bellows is delimited at its respective ends by an end plate, wherein one of the end plates is an open end plate. The filter element is for example configured to be flowed through radially from the interior to the exterior and includes at its outer circumference a grid structure which supports the filter bellows. At the grid structure, a circumferentially extending radially projecting seal carrier is provided which supports an axial seal, wherein the seal carrier is spaced apart from the open end plate in axial direction. The grid structure includes furthermore a radially inwardly projecting positioning element that supports the spread-apart portion and is open in radially outward direction as well as axially toward the side of the open end plate so that a blade provided at a filter housing may engage the positioning element.

### SUMMARY

In view of this background, the present invention has the object to provide a filter element which enables forcing an unequivocal installation position in a filter housing and which includes an improved sealing action.

This object is solved by a filter element for filtering a fluid, for example air filter element for an air filter system, for example for an intake air filter system of a fuel cell or internal combustion engine, including a filter bellows arranged around a longitudinal axis, which encloses an interior at least partially, wherein the filter bellows includes an end face first end and an oppositely positioned end face second end, and an end plate open toward the interior at the first end and a further end plate, for example a closed end plate, at the oppositely positioned second end, wherein at the end plate open toward the interior at least one circumferential seal contour is arranged which rises in direction of the longitudinal axis from the end plate open toward the interior. The filter element is characterized in that the filter bellows at its outer circumference and/or inner circumference includes at least one notch, and in that the circumferential seal contour in the region of the notch of the filter bellows includes at least one locally limited protrusion or recess in relation to a radial direction, wherein the protrusion or recess of the seal contour is arranged in circumferential direction such that its position corresponds to a circumferential position of the notch of the filter bellows.

The object is further solved by a filter device including a filter housing with a fluid inlet and a fluid outlet as well as a receiving space for a filter element in which the filter element is arranged such that it separates a raw side correlated with the fluid inlet from a clean side correlated with the fluid outlet. The filter device is characterized in that the filter element is a filter element according to the invention.

Further embodiments of the invention are described in the following in conjunction with the accompanying drawings.

A first aspect of the present invention concerns a filter element which is configured for filtering a fluid and for example may be an air filter element for an air filter system, for example for an intake air filter system of a fuel cell or internal combustion engine. However, it is in principle also possible that the filter element according to the invention may be a liquid filter element.

According to a first embodiment, the filter element according to the invention includes a filter bellows which is arranged around a longitudinal axis and which surrounds at least partially an interior, wherein the filter bellows includes an end face first end and an oppositely positioned end face second end. Furthermore, the filter element includes an end plate open toward the interior at the first end and a further end plate, for example a closed end plate, at the oppositely positioned second end. At the end plate open toward the interior, at least one circumferential seal contour is arranged which rises in the direction of the longitudinal axis away from the end plate open toward the interior. The filter bellows includes at its outer circumference and/or inner circumference at least one notch. The circumferential seal contour includes in the region of the notch of the filter bellows at least one locally limited protrusion or recess in relation to a radial direction, wherein the protrusion or recess of the circumferential seal contour is arranged in circumferential direction such that its position corresponds to a circumferential position of the notch of the filter bellows.

Herein, “first end” and “second end” refer for example to ends of the filter bellows which are facing away from each other in relation to the longitudinal axis.

The term “filter bellows” encompasses in its broadest meaning any type of filter medium bodies including at least one filter medium which may be present in a folded or non-folded form. The filter medium may be for example a particle filter medium or gas filter medium. Optionally, the filter medium may include at least one adsorber, for example an active carbon. A filter medium which is embodied as a particle filter medium, may include for example a nonwoven material, for example of synthetic fibers and/or cellulose fibers.

The filter bellows may be flowed through for example in radial direction, for example radially from the exterior to the interior so that a clean side may be present for example in the region of the interior enclosed by the filter bellows. In embodiments however, a flow radially from the interior to the exterior is also possible so that a raw side may be present in the region of the interior enclosed by the filter bellows.

The protrusion or recess of the seal contour being arranged in circumferential direction such that its position “corresponds” to a circumferential position of the notch of the filter bellows means herein for example that a positioning of the protrusion or recess of the seal contour in circumferential direction corresponds to a positioning of the notch of the filter bellows in circumferential direction. In other words, the protrusion or recess of the seal contour is arranged at a circumferential position at which also the notch of the filter bellows is present. Still expressed differently, a circumferential position of a local maximum of a deviation of the seal contour from its basic shape in the region of the protrusion or recess may coincide with a circumferential position of a lowermost position of the notch, viewed in radial direction. Smaller angular deviations between the circumferential position of the protrusion or recess of the seal contour and the notch of the filter bellows are however possible so that, for example, in case of an alignment error of up to 20°, for example up to 15°, one may still speak of a “corresponding” arrangement. Such smaller alignment errors are often unavoidable due to tolerances in the production.

The filter element according to the invention is for example a round filter element. In this context, the filter bellows may include for example a closed cross section. A cross-sectional shape of the filter medium body may be selected, for example, from the group including circular, oval, elongate oval, and kidney-shaped.

The filter bellows may include for example the shape of a straight or oblique prism, wherein its first and second ends form the respective base surface and cover surface of the prism. For example, the filter bellows may have a hollow cylindrical shape.

The filter bellows may for example surround the interior completely in circumferential direction, wherein circumferential ends initially free during the manufacture may be connected to each other in order to form a circumferentially “endless” filter bellows. In embodiments, it is however also possible that between the circumferential ends initially free during the manufacture an adapter part may be arranged which connects the initially free circumferential ends to each other. The adapter part in this context may be present for example at a circumferential position coinciding with a circumferential position of the notch.

As an alternative or in addition, the filter bellows may also widen from the first end in the direction toward the second end, or in reverse, in direction of the longitudinal axis so that, for example, a conical shape results as a whole.

The filter element according to the invention is characterized, on the one hand, by an improved sealing action because the seal contour may be guided across a major portion of the circumference along an optimal basic shape and the locally limited protrusion or recess is present only in the region of the notch of the filter bellows. On the other hand, by an asymmetric structure of the seal contour in relation to the longitudinal axis an additional angular orientation of the filter element in relation to a filter housing is made possible which supplements the spread-apart portion of the bellows functionally and thus significantly reduces the possibilities of inserting the filter element improperly in a filter housing in deviation from its predetermined angular position.

In case of a notch at the inner circumference of the filter bellows, the circumferential seal contour for example includes a locally limited protrusion in relation to a radial direction, wherein the protrusion of the seal contour is arranged in circumferential direction such that its position corresponds to a circumferential position of the notch at the inner circumference of the filter bellows.

In case of a notch at the outer circumference of the filter bellows, the circumferential seal contour includes for example a locally limited recess in relation to a radial direction, wherein the recess of the seal contour is arranged in circumferential direction such that its position corresponds to a circumferential position of the notch at the outer circumference of the filter bellows.

According to a further embodiment, the filter bellows may include a plurality of folds whose radially outer fold edges are positioned at an outer wall surface and whose radially inner fold edges are positioned at an inner wall surface. The notch in this context may be formed by a spread-apart portion of at least one fold of the filter bellows at the inner circumference and/or outer circumference.

The folds of the filter bellows may be present for example in the form of star-shaped folds, wherein the folds for example may have a constant cross-sectional shape across a major portion of the circumference. The plurality of folds may be present as V folds with fold heights that stay the same across the circumference. As an alternative, the plurality of folds may also be present as so-called W folds with intermediate folds of a reduced fold height. In the region of the notch provided by the spread-apart portion at the inner circumference and/or outer circumference, at least one fold is widened. “Widened” is to be understood such that a distance of fold edges adjoining a fold bottom or a fold tip is enlarged in comparison to neighboring folds.

According to a further embodiment, the end plate which is open toward the interior may include at least one cut which corresponds to the notch of the filter bellows and which is aligned with the at least one notch.

The cut, in case of a notch at the outer circumference of the filter bellows, may be present for example at an outer circumference of the end plate open toward the interior and extend with a radial component inwardly. The cut, in case of a notch at the inner circumference of the filter bellows, may be present for example at an inner circumference of the end plate open toward the interior and extend with a radial component outwardly.

The cut penetrates a material of the open end plate. The term “cut” serves only as a means for describing the structure of this device component and does not imply a particular manufacturing type, for example, the term is not to be understood as limited to a “cutting” manufacture.

The cut corresponding to the notch of the filter bellows “being aligned” with the at least one notch means herein that a positioning of the cut in circumferential direction corresponds to a positioning of the notch of the filter bellows in circumferential direction. In other words, the cut is arranged at a circumferential position at which also the notch of the filter bellows is present. Still expressed differently, a circumferential position of a lowermost position of the cut, viewed in radial direction, may coincide with a circumferential position of a lowermost position, viewed in radial direction, of the notch. Smaller angular deviations between the circumferential position of the cut of the open end plate and the notch of the filter bellows are however possible so that, for example, in case of an alignment error of up to 20°, for example up to 15°, one may still speak of a ‘corresponding arrangement”. Such smaller alignment errors are often unavoidable due to tolerances in the production.

In embodiments, the notch may be present at least at the first end of the filter bellows. This means that the notch is present at least at the end of the filter bellows at which the end plate open toward the interior is arranged.

In this context, it is either possible that the notch extends in direction of the longitudinal axis across a total extension of the filter bellows or that the notch in direction of the longitudinal axis is shorter than the total extension of the filter bellows and for example is present only at a longitudinal portion of the filter bellows close to the first end.

In embodiments in which the notch is formed by a spread-apart portion of at least one fold of the filter bellows at the inner circumference and/or outer circumference, the spread-apart portion for example may be present only at a longitudinal portion of the filter bellows close to the first end, wherein, for example in a longitudinal portion of the filter bellows remote from the first end, the spread-apart portion reverts to a uniform fold shape which corresponds to that of the plurality of the folds of the filter bellows.

According to a further embodiment, the circumferential seal contour may have a predetermined basic shape, wherein a circumferential course of the circumferential seal contour in the region of the locally limited protrusion or recess deviates from the predetermined basic shape. The predetermined basic shape may be for example a circular shape. However, also other basic shapes are possible such as, for example, an oval or flatly oval shape. A “basic shape” is understood as the course of the seal contour in a plane of the first end of the filter bellows, respectively, in a plane of the end plate open toward the interior in circumferential sections without protrusion or recess.

In embodiments, the end plate open toward the interior may include or be included of a plastic material, for example a foamed plastic material, for example a polyurethane foam, wherein for example the circumferential seal contour is one piece together with the end plate open toward the interior. The end plate open toward the interior may be connected to the first end of the filter bellows, for example connected by material fusion, for example welded, glued or foamed on.

The circumferential seal contour together with the end plate open toward the interior may be produced in a casting process by using a foamable and flowable plastic material so that the provision of the protrusion or recess of the seal contour incurs no additional expenditure for the manufacture.

According to yet another embodiment, the filter element may include a fluid-permeable support grid arranged at the inner circumference of the filter bellows that for example includes a radial bulge which protrudes into a notch present at the inner circumference of the filter bellows.

The radial bulge of the support grid arranged at the inner circumference of the filter bellows serves in this context for example to support the notch present at the inner circumference of the filter bellows, to stabilize it and/or keep it open.

The fluid-permeable support grid may include or be included of a plastic material, for example plastic material capable of being injection-molded. The radial bulge of the support grid arranged at the inner circumference of the filter bellows may be for example one piece together with the support grid.

According to another embodiment, the filter bellows may include at its outer circumference and/or inner circumference at least two notches which are spaced apart in circumferential direction, wherein the circumferential seal contour in the region of the notches of the filter bellows includes a locally limited protrusion or recess in relation to the radial direction, respectively. The respective protrusion or recess of the seal contour in this context is arranged in circumferential direction such that its position corresponds to a circumferential position of the respective notch of the filter bellows.

By providing more than one notch at the outer circumference and/or inner circumference of the filter bellows in combination with a respective locally limited protrusion or recess of the seal contour, the forcing of a predetermined installation position in a filter housing may be further improved. Furthermore, it is possible by a variation of the circumferential arrangement of the notches of the filter bellows and the respective corresponding protrusions or recesses of the seal contour to realize an application-specific coding of an interface between the filter element and a filter housing.

In embodiments, it is for example possible that a notch at the inner circumference and a second notch at the outer circumference of the filter bellows are present. The notch at the inner circumference and the notch at the outer circumference may be for example spaced apart in circumferential direction.

In the region of the notch at the inner circumference of the filter bellows, the circumferential seal contour in this context includes a locally limited protrusion in relation to a radial direction, wherein the protrusion of the seal contour is arranged in circumferential direction such that its position corresponds to a circumferential position of the notch at the inner circumference of the filter bellows.

In the region of the notch at the outer circumference of the filter bellows, the circumferential seal contour in this context includes a locally limited recess in relation to a radial direction, wherein the recess of the seal contour is arranged in circumferential direction such that its position corresponds to a circumferential position of the notch at the outer circumference of the filter bellows.

According to a further embodiment, the end plate open toward the interior may include cuts which correspond respectively to the notches at the filter bellows and which are aligned respectively with one of the notches of the filter bellows. In this context, a notch at the outer circumference of the filter bellows may have correlated therewith for example a cut at an outer circumference of the open end plate and a notch at the inner circumference of the filter bellows may have correlated therewith a cut at an inner circumference of the open end plate.

Finally, according to a further embodiment, the circumferential seal contour may include at least one circumferential radial seal surface, for example at an inner circumference.

As an alternative, the circumferential seal contour may include more than two radial seal surfaces, for example, a first radial seal surface at the inner circumference and a second radial seal surface at the outer circumference. As an alternative or in addition, it is possible that the circumferential seal contour includes at least one axial seal surface, for example at an end face of the circumferential seal contour. The seal contour may include a predetermined seal profile (radial section) that may include one or a plurality of seal strands, for example extending parallel to each other. The present invention is, however, explicitly not limited to a certain action direction of the sealing action and/or certain seal profiles. Instead, any seal profiles which appear suitable to a person of skill in the art may be used.

A second aspect of the present invention concerns a filter device, including a filter housing with a fluid inlet and a fluid outlet as well as with a receiving space for a filter element in which a filter element according to the first aspect of the present invention is arranged such that it separates a raw side correlated with the fluid inlet from a clean side correlated with the fluid outlet.

The filter device may be for example an air filter device, for example an intake air filter device of a fuel cell or internal combustion engine or a cabin air filter device. The filter housing may be for example an air filter housing.

According to an embodiment, the filter housing may include at least one circumferential housing seal surface at which the circumferential seal contour of the filter element is resting, wherein the housing seal surface includes at least one locally limited protrusion or recess which corresponds to the at least one locally limited protrusion or recess of the circumferential seal contour of the filter element.

The filter housing may be for example of a two-part configuration and include a housing pot in which the receiving space is present as well as a housing cover which is releasably connected to the housing pot. The housing seal surface may be present in this context either at the housing pot or at the housing cover.

The interaction between the housing seal surface and the circumferential seal contour of the filter element represents in this context the functional main interface between the filter housing and the filter element. Its main function, namely sealing of the raw side from the clean side, may be fulfilled by the main interface only when the housing seal surface matches the structure of the circumferential seal contour of the filter element, wherein for example the housing seal surface at least in sections may have the shape of a negative mold of the seal contour of the filter element.

Since the housing seal surface as well as the circumferential seal contour of the filter element are not rotationally symmetrical in relation to the longitudinal axis, an installation position of the filter element in the filter housing predetermined in relation to the longitudinal axis may already be reliably forced by an interaction of the filter element and filter housing at the main interface.

As an alternative or in addition, the filter housing may include at least one housing projection projecting into the receiving space and received in the at least one notch of the filter element.

By the combination of a housing seal surface with at least one locally limited protrusion or recess at which the circumferential seal contour of the filter element is resting and of a housing projection which is received in the at least one notch of the filter element, the installation position of the filter element predetermined in relation to the longitudinal axis may be forced in the best possible manner, wherein improper uses of the filter device are substantially excluded.

It is understood that features, feature combinations, as well as their specific advantages disclosed in relation to the first aspect of the present invention may be applied to the second aspect of the present invention, and vice versa.

Further possible implementations of the invention include also not explicitly mentioned combinations of features described above or in the following in relation to the embodiments. In this context, a person of skill in the art will also add individual aspects as improvements or supplements to the respective basic form of the invention.

In the following, the invention will be explained in more detail with the aid of embodiments with reference to the attached drawing figures.

### BRIEF DESCRIPTION OF THE DRAWINGS

FIG. 1 shows an isometric view of a filter element according to the invention according to a first embodiment.

FIG. 2 shows a longitudinal section of the filter element according to the invention according to the first embodiment.

FIG. 3 shows a plan view of the filter element according to the invention according to the first embodiment from the side of the open end plate.

FIG. 4 shows an isometric exploded view of a filter device according to the invention according to a first embodiment.

FIG. 5 shows an isometric view of a filter device according to the invention according to the first embodiment.

FIG. 6 shows a plan view of the filter device according to the invention according to the first embodiment from the side of the fluid outlet.

FIG. 7 shows a longitudinal section of the filter device according to the invention according to the first embodiment.

FIG. 8 shows detail VIII of FIG. 7.

FIG. 9 shows section IX-IX according to FIG. 7.

FIG. 10 shows an isometric view of a filter element according to the invention according to a second embodiment.

FIG. 11 shows a longitudinal section of the filter element according to the invention according to the second embodiment.

FIG. 12 shows a plan view of the filter element according to the invention according to the second embodiment from the side of the open end plate.

FIG. 13 shows an isometric exploded view of a filter device according to the invention according to a second embodiment.

FIG. 14 shows an isometric view of the filter device according to the invention according to the second embodiment.

FIG. 15 shows a plan view of the filter device according to the invention according to the second embodiment from the side of the fluid outlet.

FIG. 16 shows a longitudinal section of the filter device according to the invention according to the second embodiment.

FIG. 17 shows detail XVII of FIG. 16.

FIG. 18 shows section XVIII-XVIII according to FIG. 16.

FIG. 19 shows an isometric view of a filter element according to the invention according to a third embodiment.

FIG. 20 shows a plan view of the filter element according to the invention according to the third embodiment from the side of the open end plate.

FIG. 21 shows an isometric exploded view of a filter device according to the invention according to a third embodiment.

FIG. 22 shows an isometric view of a filter housing part of a filter device according to the invention according to the third embodiment.

FIG. 23 shows a section view of a filter device according to the invention according to the third embodiment.

### DETAILED DESCRIPTION

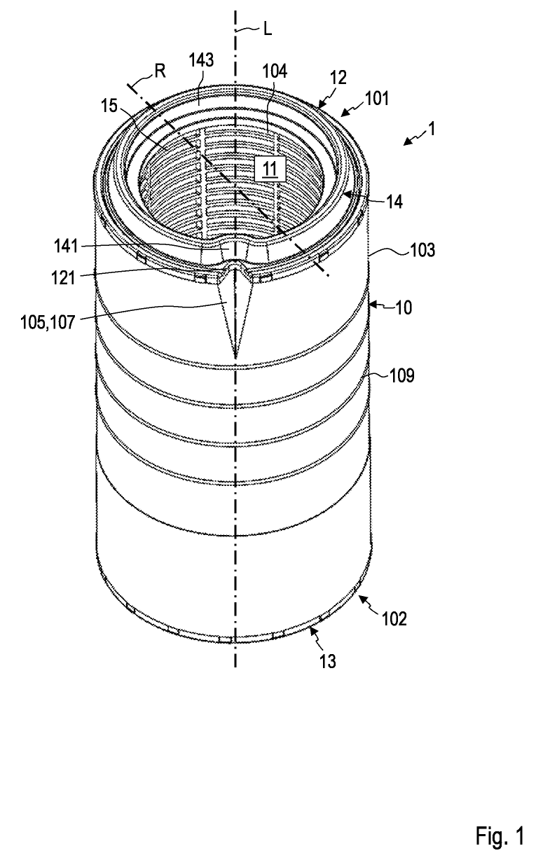

FIG. 1 shows a filter element 1 according to the invention for filtering a fluid, for example an air filter element for an air filter system, for example for an intake air filter system of a fuel cell or internal combustion engine, according to a first embodiment of the invention. The filter element is a round filter element whose filter bellows 10 comprises a hollow cylindrical shape. The filter element 1 comprises the filter bellows 10 arranged around a longitudinal axis L which encloses an interior 11. The filter bellows 10 has an end face first end 101 and an oppositely positioned end face second end 102. At the first end 101, an end plate 12 open toward the interior 11 is arranged, wherein an opening of the open end plate 12 is in fluid communication with the interior 11. At the second end 102, a further end plate 13 is arranged which for example may be a closed end plate 13. At the end plate 12 open toward the interior 11, at least one circumferential seal contour 14 is arranged which surrounds the opening in the open end plate 12 completely circumferentially. The circumferential seal contour 14 rises in direction of the longitudinal axis L from the end plate 12 open toward the interior 11.

The filter bellows 10 comprises a notch 105 at its outer circumference 103. In the region of the notch 105 at the outer circumference 103 of the filter bellows 10, the circumferential seal contour 14 has a locally limited recess 141 in relation to the radial direction R, wherein the recess 141 of the seal contour 14 is arranged in circumferential direction such that its position corresponds to a circumferential position of the notch 105 at the outer circumference 103 of the filter bellows 10.

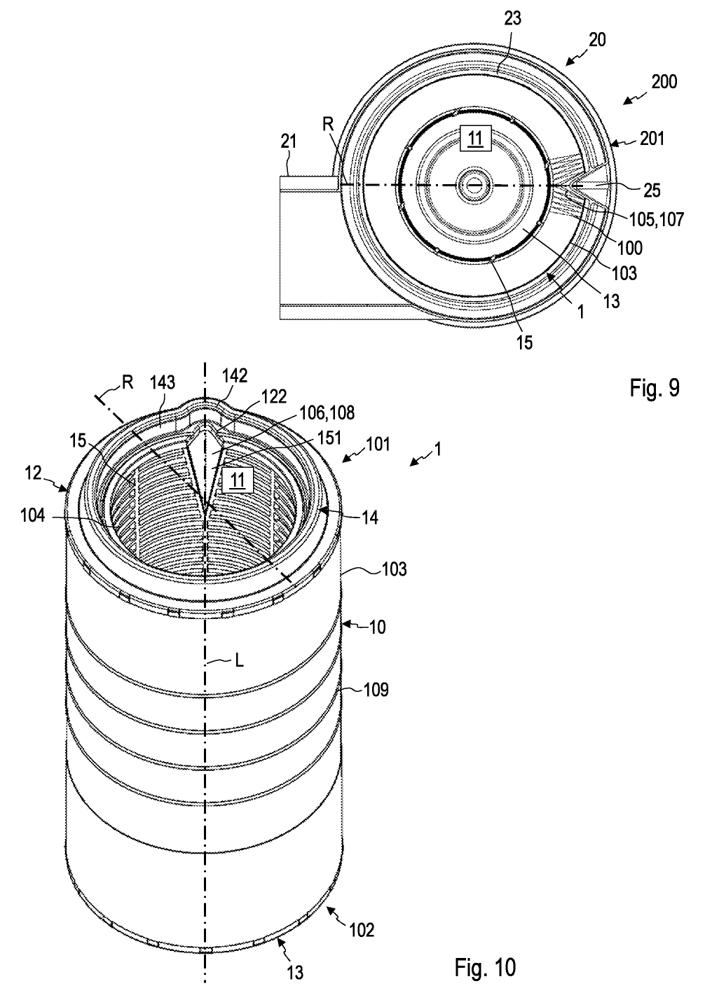

The filter bellows 10 comprises a plurality of folds 100 whose radially outer fold edges are positioned at an outer wall surface and whose radially inner fold edges are positioned at an inner wall surface. The fold edges of the folds 100 extend substantially parallel to the longitudinal axis L. The notch 105 at the outer circumference 103 of the filter bellows 10 is formed by a spread-apart portion 107 of at least one fold 100 of the filter bellows 10 at the outer circumference (see FIG. 9).

The folds 100 of the filter bellows 10 have for example the form of star-shaped folds, wherein the folds may have a uniform cross-sectional shape across a major portion of the circumference. At least one fold 100 is widened in the region of the notch 105 provided by the spread-apart portion 107 at the outer circumference 103.

The end plate 12 open toward the interior has a cut 121 at its outer circumference which corresponds to the notch 105 at the outer circumference 103 of the filter bellows 10 and which is aligned with the notch 105. The cut 121 may be understood as a local material cutout of the open end plate 12 and extends from the outer circumference of the open end plate 12 with a radial component inwardly. The cut comprises two oppositely positioned cut walls which extend at an for example acute angle relative to each other.

The notch 105 at the outer circumference 103 of the filter bellows 10 is positioned at the first end 101 of the filter bellows 10 and is shorter in the direction of the longitudinal axis L than the total extension of the filter bellows 10, for example, the notch 105 is present only at a length portion of the filter bellows 10 close to the first end 101. At a length portion of the filter bellows 10 remote from the first end 101, the notch 105 provided as a spread-apart portion 107 reverts to a uniform fold shape which corresponds to that of the plurality of the folds 100 of the filter bellows 10, which may be seen in the drawing figures by means of the structure of the spread-apart portion 107 tapering in the direction of the second end 102.

The basic shape of the circumferential seal contour 14 is a circle, wherein a circumferential course of the circumferential seal contour 14 in the region of the locally limited recess 141 deviates from the circular shape. The locally limited recess 141 forms a nose which is protruding away from the circular shape inwardly.

The open end plate 12 comprises or is comprised of a plastic material, for example a foamed plastic material, for example a polyurethane foam. The circumferential seal contour 14 is for example one piece together with the end plate 12 open toward the interior. The end plate 12 open toward the interior is connected to the first end 101 of the filter bellows 10 for example by material fusion, for example welded, glued or foamed on.

At the inner circumference 104 of the filter bellows 10, a fluid-permeable support grid 15 is arranged that is for example configured to support the filter bellows 10 upon flow from the exterior to the interior in radial direction (clean side in the interior 11) against occurring differential pressures. The fluid-permeable support grid 15 may be embedded at the first end 101 in a material of the open end plate 12, for example may be enclosed by a foamed plastic material of the open end plate 12.

At the outer circumference 103 of the filter bellows 10, a plurality of fold stabilization means 109 are arranged which surround the filter bellows 10. The fold stabilization means 109 are spaced apart from each other in relation to the longitudinal axis L. The fold stabilization means 109 support the folds 100 of the filter bellows 10 and hold them in shape, which is for example important in case of a sudden liquid load on a filter element 1 which is embodied as an air filter element. The fold stabilization means 109 may be, for example, strings or yarn glued to the fold tips of the filter bellows 10.

The circumferential seal contour 14 may comprise a circumferential radial seal surface 143 which is present at an inner circumference.

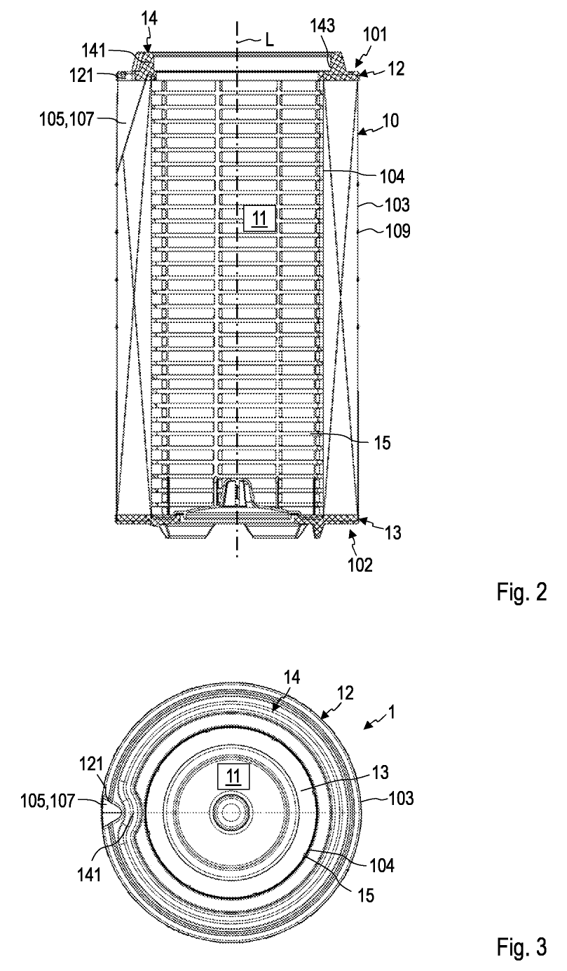

In the longitudinal section of FIG. 2, the notch 105 configured as a spread-apart portion 107 at the outer circumference 103 of the filter bellows 10 is seen more clearly; furthermore, the locally limited recess 141 in relation to the radial direction R of the circumferential seal contour 14, which is arranged in circumferential direction such that its position corresponds to a circumferential position of the notch 105 at the outer circumference 103 of the filter bellows 10, is seen. For example, it is seen that a distance of the circumferential seal contour 14 from the longitudinal axis L at the left side in the illustration is smaller than at the right side in the illustration.

The notch 105 formed by the spread-apart portion 107 at the outer circumference 103 of the filter bellows 10 comprises an intermediate fold with a fold base extending at a slant in relation to the longitudinal axis.

FIG. 3 shows a plan view of the filter element 1 according to the first embodiment from the side of the open end plate 12, wherein through the interior 11 the additional end plate 13, which here is a closed end plate, is seen.

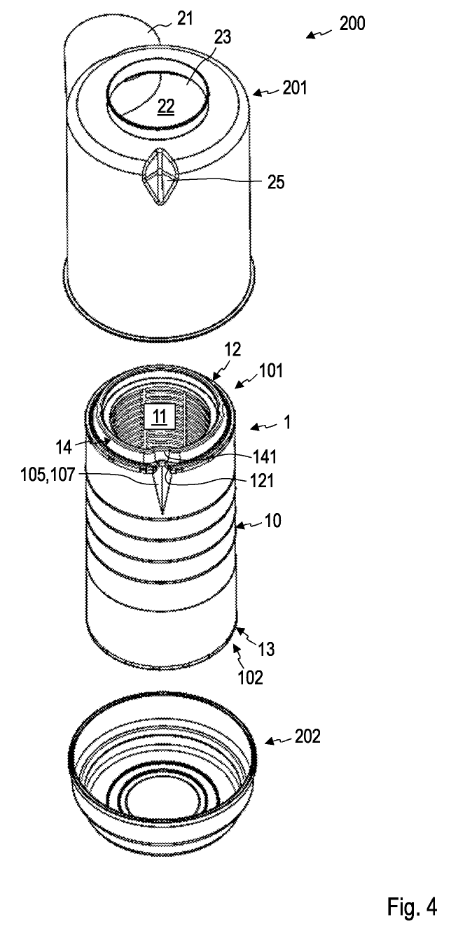

FIG. 4 shows an isometric exploded view of a filter device 200 according to the invention according to a first embodiment. The filter device 200 comprises a filter housing 20 with a fluid inlet 21 at a first housing part 201, for example a housing pot 201, and with a fluid outlet 22 at the first housing part 201. The first housing part 201 configured as a housing pot 201 provides a receiving space 23 for a filter element 1 in which, in a mounted state, the filter element 1 is arranged such that it separates a raw side correlated with the fluid inlet 21 from a clean side correlated with the fluid outlet 22.

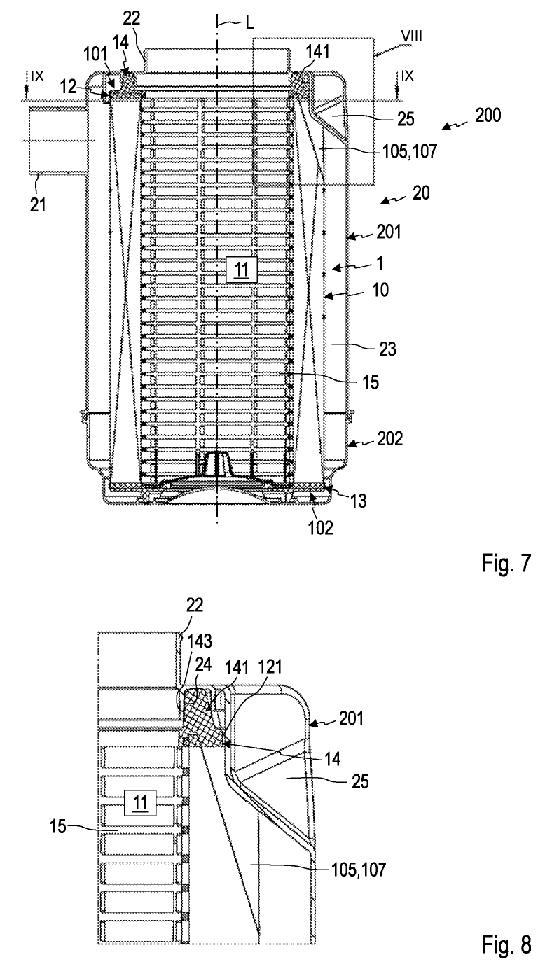

The first housing part 201 comprises a circumferential housing seal surface 24 at which the circumferential seal contour 14 of the filter element 1 may be brought into contact (see FIG. 7), wherein the housing seal surface 24 comprises a locally limited recess which corresponds to the one locally limited recess 141 of the circumferential seal contour 14 of the filter element 1. Furthermore, the first housing part 201 comprises a housing projection 25 which projects into the receiving space 23 and which, in the mounted state, may be received in the notch 105 at the outer circumference 103 of the filter element 1 so that the filter element 1 is positioned unequivocally in the first housing part 201 in respect to its installation position about the longitudinal axis L.

The filter housing 20 comprises furthermore a second housing part 202 in the form of a housing cover 202 which is connectable detachably to the first housing part 201 in order to close the receiving space 23.

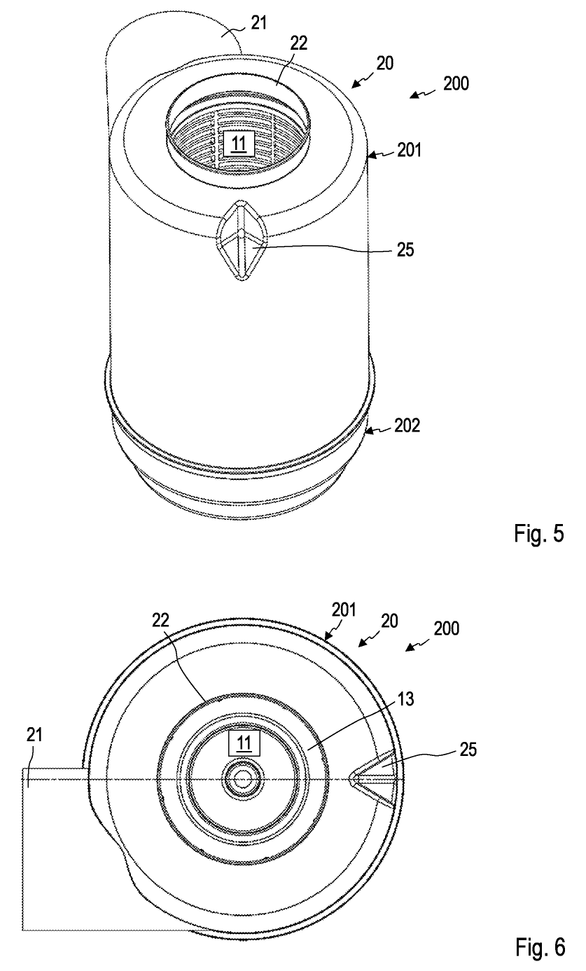

FIG. 5 shows the filter device 200 in the mounted state, i.e., with inserted filter element 1 and second housing part 202 detachably connected to the first housing part 201.

In FIG. 6, a plan view of the filter device 200 according to the invention according to the first embodiment is illustrated from the side of the fluid outlet 22, wherein through the fluid outlet 22 the interior 11 of the filter element 1 and its further end plate 13 are seen. The housing projection 25 extends from an outer wall of the first housing part 201 with a radial component inwardly and comprises a predetermined extension in direction of the longitudinal axis so that the latter may pass through the cut 121 of the open end plate 12 of the filter element 1 into the notch 105 which is embodied as a spread-apart portion 107 at the outer circumference 103 of the filter element 1. The housing projection 25 comprises two projection walls which are facing away from each other and are positioned at an acute angle relative to each other so that, for example, a housing projection 25 with an overall triangular shape results.

In FIG. 7, FIG. 8, and FIG. 9, the engagement of the housing projection 25, through the cut 121 at the outer circumference of the open end plate 12 of the filter element 1, in the notch 105 configured as a spread-apart portion 107 at the outer circumference 103 of the filter element 1 is seen even more clearly.

In FIG. 9, furthermore the structure of the notch 105 configured as a spread-apart portion 107 at the outer circumference 103 of the filter element 1 is illustrated even more clearly. The folds 100 of the filter bellows 10 are present in form of star folds, wherein the folds 100 across a major portion of the circumference have a uniform cross-sectional shape. In the region of the notch 105 provided by the spread-apart portion 107 at the outer circumference 103, one fold 100 is widened, which means that a distance of fold edges adjoining a fold bottom or a fold tip at the outer circumference in comparison to neighboring folds is enlarged so that the housing projection 25 may engage therein.

FIG. 10 shows an isometric view of a filter element 1 according to the invention according to a second embodiment which, with respect to its basic structure, is very similar to the filter element 1 according to the first embodiment so that only the differences will be explained.

In the region of a notch 106 at the inner circumference 104 of the filter bellows 10, the circumferential seal contour 14 has locally limited protrusion 142 in relation to the radial direction R, wherein the protrusion 142 of the seal contour 14 is arranged in circumferential direction such that its position corresponds to a circumferential position of the notch 106 at the inner circumference 104 of the filter bellows 10.

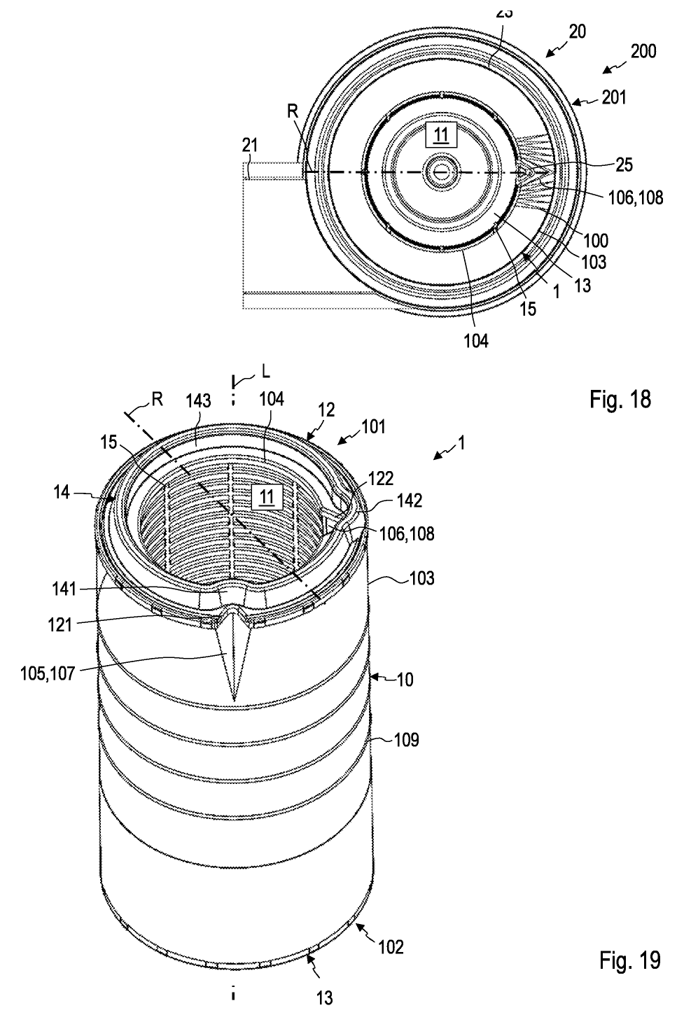

The notch 106 at the inner circumference 104 of the filter bellows 10 is formed by a spread-apart portion 108 of at least one fold 100 of the filter bellows 10 at the inner circumference 104 (see FIG. 18). The folds 100 of the filter bellows 10 have for example the shape of star folds, wherein the folds may have across a major portion of the circumference a uniform cross-sectional shape. At least one fold 100 is widened in the region of the notch 106 provided by the spread-apart portion 108 at the inner circumference 104.

The end plate 12 open toward the interior has a cut 122 at its circumference which corresponds to the notch 106 at the inner circumference 104 of the filter bellows 10 and which is aligned with the notch 106. The cut 122 may be understood as a local material cutout of the open end plate 12 and extends from the inner circumference of the open end plate 12 with a radial component R outwardly. The cut 122 comprises two oppositely positioned cut walls which extend for example, at an acute angle relative to each other.

The notch 106 at the inner circumference 104 of the filter bellows 10 is positioned at the first end 101 of the filter bellows 10 and is shorter in direction of the longitudinal axis L than the total extension of the filter bellows 10, for example, the notch 106 is present only at a longitudinal portion of the filter bellows 10 which is close to the first end 101. At a longitudinal portion of the filter bellows 10 remote from the first end 101, the notch 106 provided as a spread-apart portion 108 reverts to a uniform fold shape which corresponds to that of the plurality of the folds 100 of the filter bellows 10, which may be seen in the drawing figures by means of the structure of the spread-apart portion 108 tapering in the direction of the second end 102.

The basic shape of the circumferential seal contour 14 is a circle, wherein a circumferential course of the circumferential seal contour 14 in the region of the locally limited protrusion 142 deviates from the circular shape. The locally limited protrusion 142 forms a nose which is protruding outwardly away from the circular shape.

At the inner circumference 104 of the filter bellows 10, a fluid-permeable support grid 15 is arranged that is for example configured to support the filter bellows 10 upon flow from the exterior to the interior in radial direction (clean side in the interior 11) against occurring differential pressures. The fluid-permeable support grid 15 may be embedded at the first end 101 in a material of the open end plate 12, for example in a foamed plastic material. The fluid permeable support grid 15 comprises a radial bulge 151 which projects into the notch 106 present at the inner circumference 104 of the filter bellows 10 in order to support it.

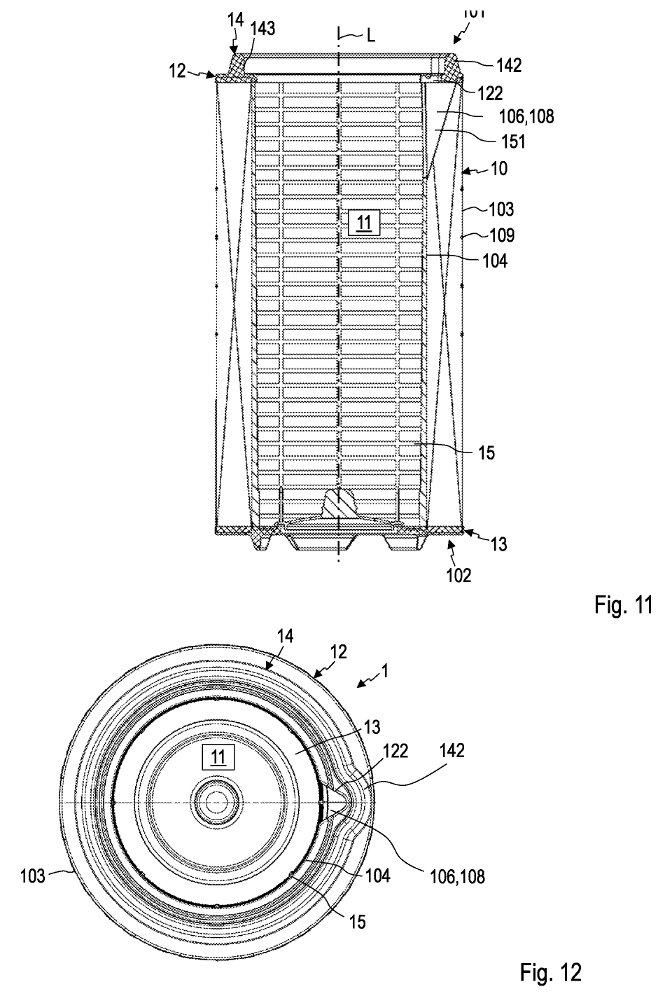

In the longitudinal section of FIG. 11, the notch 106, which is configured as a spread-apart portion 108, at the inner circumference 104 of the filter bellows 10 is seen more clearly; furthermore, the locally limited protrusion 142 in relation to the radial direction R of the circumferential seal contour 14, which is arranged in circumferential direction such that its position corresponds to a circumferential position of the notch 106 at the inner circumference 104 of the filter bellows 10, is seen. For example, it is seen that a distance of the circumferential seal contour 14 from the longitudinal axis L is larger at the right side in the illustration than at the left side in the illustration.

The notch 106 embodied as a spread-apart portion 108 at the inner circumference 104 of the filter bellows 10 comprises an intermediate fold with a fold base extending at a slant in relation to the longitudinal axis.

FIG. 12 shows a plan view of the filter element 1 according to the second embodiment from the side of the open end plate 12, wherein through the interior 11 the further end plate 13 which here is a closed end plate may be seen.

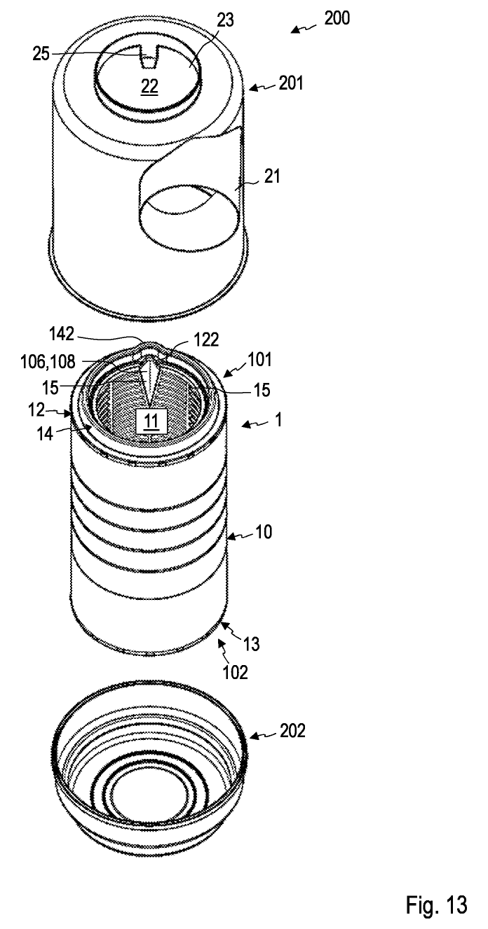

FIG. 13 shows an isometric exploded view of a filter device 200 according to the invention according to a second embodiment which with respect to its basic configuration is very similar to the filter device 200 according to the first embodiment so that only the differences will be explained. In deviation from the first embodiment, the first housing part 201 comprises a housing projection 25 which projects into the receiving space 23 and which, in the mounted state, is receivable in the notch 106 at the inner circumference 104 of the filter element 1 so that the filter element 1 in relation to its installation position about the longitudinal axis L is positioned unequivocally in the first housing part 201. The housing projection 25 is for example arranged neighboring an inner circumference of the fluid outlet 22 and extends with a radial component outwardly and comprises a predetermined extension in direction of the longitudinal axis so that the latter may engage, through the cut 122 of the open end plate 12 of the filter element 1, in the notch 106 configured as a spread-apart portion 108 at the inner circumference 104 of the filter element 1.

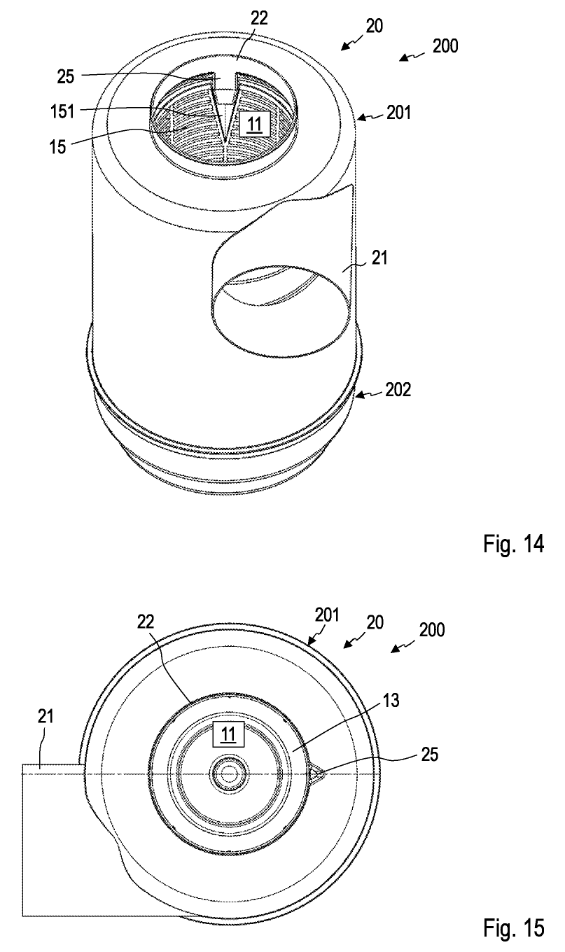

FIG. 14 shows the filter device 200 in the mounted state, i.e., with inserted filter element 1 and second housing part 202 fastened releasably at the first housing part 201, wherein the housing projection 25 engages the notch 106 configured as a spread-apart portion 108 at the inner circumference 104 of the filter element 1.

In FIG. 15, a plan view of the filter device 200 according to the invention according to the second embodiment is illustrated from the side of the fluid outlet 22, wherein the interior 11 of the filter element 1 and its further end plate 13 is seen through the fluid outlet 22.

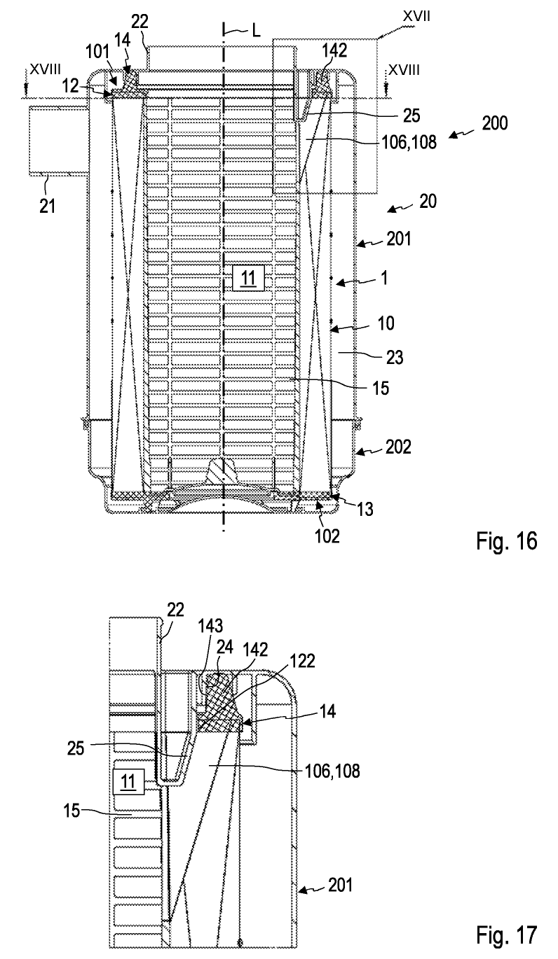

In FIG. 16, FIG. 17, and FIG. 18, the engagement of the housing projection 25, through the cut 122 at the inner circumference of the open end plate 12 of the filter element 1, in the notch 106 embodied as a spread-apart portion 108 at the inner circumference 104 of the filter element 1 is seen even more clearly.

In FIG. 18, furthermore the structure of the notch 106 embodied as a spread-apart portion 108 at the inner circumference 104 of the filter element 1 is even better illustrated. The folds 100 of the filter bellows 10 are present in the form of star folds, wherein the folds 100 across a major portion of the circumference have a uniform cross-sectional shape. In the region of the notch 106 provided by the spread-apart portion 108 at the inner circumference 104, a fold 100 is widened which means that a distance of fold edges adjoining a fold bottom or a fold tip at the inner circumference 104 is enlarged in comparison to neighboring folds so that the housing projection 25 may engage therein.

FIG. 19 shows an isometric view of a filter element 1 according to the invention according to a third embodiment which with regard to its basic configuration is very similar to the filter element 1 according to the first and the second embodiments so that only the differences will be explained.

The filter bellows 10 comprises a notch 105 at its outer circumference 103. In the region of the notch 105 at the outer circumference 103 of the filter bellows 10, the circumferential seal contour 14 has a locally limited recess 141 in relation to the radial direction R, wherein the recess 141 of the seal contour 14 is arranged in circumferential direction such that its position corresponds to a circumferential position of the notch 105 at the outer circumference 103 of the filter bellows 10.

The filter bellows 10 comprises a plurality of folds 100 whose radially outer fold edges are located at an outer wall surface and whose radially inner fold edges are located at an inner wall surface. The fold edges of the folds 100 extend substantially parallel to the longitudinal axis L. The notch 105 at the outer circumference 103 of the filter bellows 10 is formed by a spread-apart portion 107 of at least one fold 100 of the filter bellows 10 at the outer circumference 103 (see FIG. 23).

The end plate 12 open toward the interior has a cut 121 in its outer circumference which corresponds to the notch 105 at the outer circumference 103 of the filter bellows 10 and which is aligned with the notch 105.

The circumferential seal contour 14 has furthermore in the region of a notch 106 at the inner circumference 104 of the filter bellows 10 a locally limited protrusion 142 in relation to the radial direction R, wherein the protrusion 142 of the seal contour 14 is arranged in circumferential direction such that its position corresponds to a circumferential position of the notch 106 at the inner circumference 104 of the filter bellows 10.

The notch 106 at the inner circumference 104 of the filter bellows 10 and the notch 105 at the outer circumference 103 of the filter bellows 10 are spaced apart from each other in circumferential direction.

The end plate 12 open toward the interior has a cut 122 at its inner circumference which corresponds to the notch 106 at the inner circumference 104 of the filter bellows 10 and which is aligned with the notch 106.

The basic shape of the circumferential seal contour 14 is a circle, wherein a circumferential course of the circumferential seal contour 14 in the region of the locally limited protrusion 142 and of the locally limited recess 141 deviates from the circular shape. The locally limited protrusion 142 forms a nose which is projecting outwardly away from the circular shape. The locally limited recess 141 forms a nose which is projecting radially inwardly away from the circular shape.

The fluid-permeable support grid 15 comprises a radial bulge 151 which protrudes into the notch 106 at the inner circumference 104 of the filter bellows 10 in order to support it.

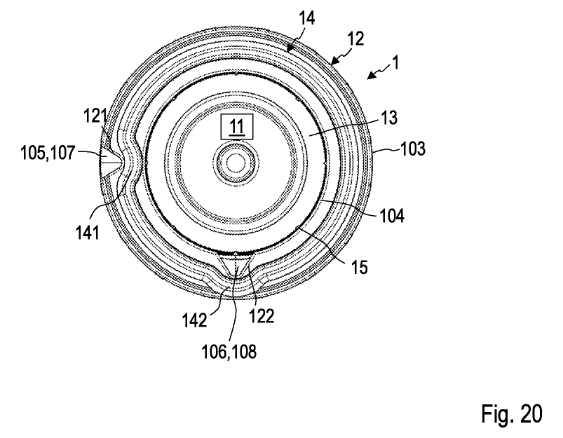

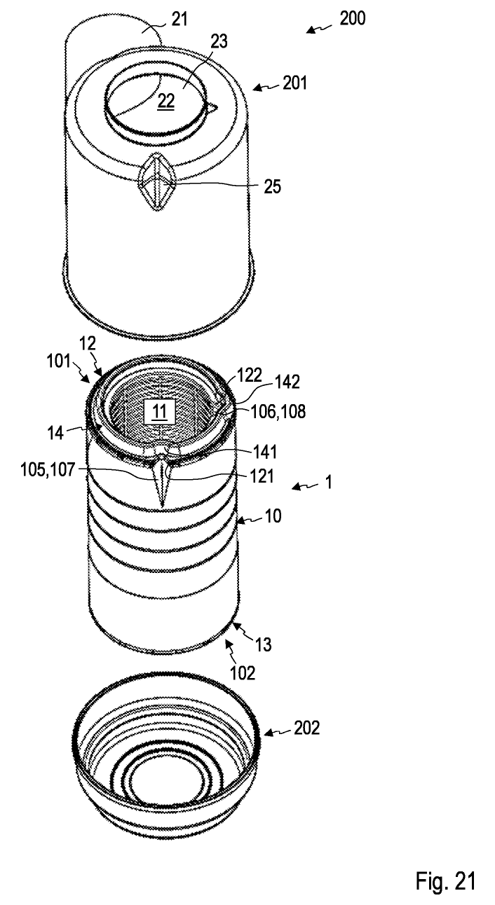

FIG. 20 shows a plan view of the filter element 1 according to the third embodiment from the side of the open end plate 12 wherein the further end plate 13, which here is a closed end plate, is seen through the interior 11.

FIG. 21 shows an isometric exploded view of a filter device 200 according to the invention according to a third embodiment which with respect to its basic configuration is very similar to the filter device 200 according to the first embodiment and the second embodiment so that only the differences will be explained. The first housing part 201 comprises a first housing projection 25 projecting into the receiving space 23 which, in the mounted state, is receivable in the notch 106 at the inner circumference of the filter element 1. Furthermore, the first housing part 201 comprises a second housing projection 25 projecting into the receiving space 23 which, in the mounted state, is receivable in the notch 105 at the outer circumference 103 of the filter element 1.

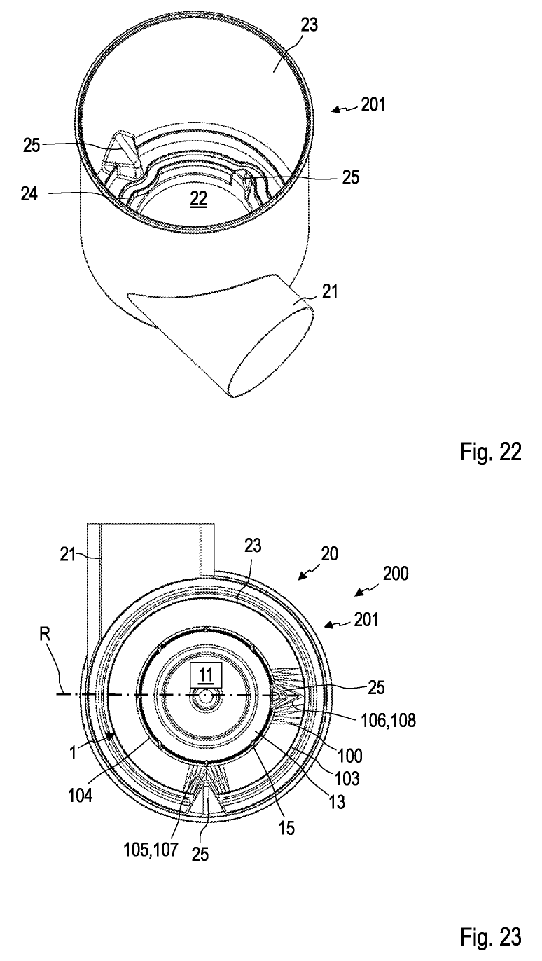

FIG. 22 shows an isometric view of the first filter housing part 201 of the filter device according to the invention according to the third embodiment. The first filter housing part 201 is for example a housing pot 201 with a receiving space 23 for the filter element 1. The first housing part 201 comprises two housing projections 25 of which a first housing projection 25, in the mounted state, is receivable in the notch 106 at the inner circumference 104 of the filter element 1 and a second housing projection 25, in the mounted state, is receivable in the notch 105 at the outer circumference 103 of the filter element 1. The housing seal surface 24 comprises a locally limited protrusion which corresponds to the locally limited protrusion 142 of the circumferential seal contour 14 of the filter element 1. Furthermore, the housing seal surface 24 comprises a locally limited recess which corresponds to the locally limited recess 141 of the circumferential seal contour 14 of the filter element 1. The protrusion and the recess of the housing seal surface 24 are spaced apart from each other in circumferential direction.

In FIG. 23, the structure of the notch 105 configured as spread-apart portion 107 at the outer circumference 103 of the filter element 1 is yet illustrated even better. The folds 100 of the filter bellows 10 are present in the form of star folds, wherein the folds 100 across a major portion of the circumference have a uniform cross-sectional shape. In the region of the notch 105 provided by the spread-apart portion 107 at the outer circumference, a fold 100 is widened so that the second housing projection 25 may engage therein.

Furthermore, the structure of the notch 106 configured as a spread-apart portion 108 at the inner circumference 104 of the filter element 1 is seen. In the region of the notch 106 provided by the spread-apart portion 108 at the inner circumference 104, a fold 100 is widened so that the first housing projection 25 may engage therein.

### Reference Characters:

1 filter element

10 filter bellows

11 interior

12 end plate open toward the interior

13 further end plate, for example closed end plate

14 circumferential seal contour

15 support grid

20 filter housing

21 fluid inlet

22 fluid outlet

23 receiving space

24 housing seal surface

25 housing projection

100 folds

101 end face first end

102 end face second end

103 outer circumference

104 inner circumference

105 notch at the outer circumference

106 notch at the inner circumference

107 spread-apart portion at the outer circumference

108 spread-apart portion at the inner circumference

109 fold stabilization means

121 cut at the outer circumference

122 cut at the inner circumference

141 recess of the circumferential seal contour

142 protrusion of the circumferential seal contour

143 radial seal surface

151 bulge

200 filter device

201 housing pot

202 housing cover

L longitudinal axis

R radial direction

1. A filter element for filtering a fluid, the filter element comprising:
a filter bellows arranged around a longitudinal axis and enclosing an interior at least partially;
wherein the filter bellows comprises a first end and an oppositely positioned second end;
wherein the filter bellows comprises a first end plate open toward the interior arranged at the first end and a second end plate arranged at the oppositely positioned second end;
at least one circumferential seal contour arranged at the first end plate and rising in a direction of the longitudinal axis away from the first end plate;
wherein the filter bellows comprises an outer circumference and an inner circumference and further comprises at least one notch arranged at the outer circumference and/or at the inner circumference;
wherein the at least one circumferential seal contour in a region of the at least one notch comprises at least one locally limited protrusion or recess in relation to a radial direction, wherein the at least one locally limited protrusion or recess of the at least one circumferential seal contour is arranged in a circumferential direction such that a position of the at least one locally limited protrusion or recess corresponds to a circumferential position of the at least one notch.

2. The filter element according to claim 1, wherein the filter bellows comprises a plurality of folds comprising radially outer fold edges positioned at an outer wall surface and further comprising radially inner fold edges positioned at an inner wall surface, wherein the at least one notch is formed by a spread-apart portion of at least one fold of the plurality of folds at the inner circumference and/or at the outer circumference.

3. The filter element according to claim 1, wherein the first end plate comprises at least one cut corresponding to the at least one notch and aligned with the at least one notch.

4. The filter element according to claim 1, wherein the at least one notch is present at least at the first end of the filter bellows.

5. The filter element according to claim 1, wherein the at least one notch extends in a direction of the longitudinal axis across a total extension of the filter bellows.

6. The filter element according to claim 1, wherein the at least one notch is shorter in a direction of the longitudinal axis than a total extension of the filter bellows.

7. The filter element according to claim 6, wherein the at least one notch is present only at a longitudinal portion of the filter bellows close to the first end.

8. The filter element according to claim 1, wherein the at least one circumferential seal contour comprises a predetermined shape and wherein a circumferential course of the at least one circumferential seal contour in a region of the at least one locally limited protrusion or recess deviates from the predetermined shape.

9. The filter element according to claim 8, wherein the predetermined shape is a circular shape.

10. The filter element according to claim 1, wherein the filter bellows comprises a hollow cylindrical configuration and surrounds the interior completely in the circumferential direction.

11. The filter element according to claim 1, further comprising a fluid-permeable support grid arranged at the inner circumference of the filter bellows.

12. The filter element according to claim 11, wherein the fluid-permeable support grid comprises a radial bulge protruding into the at least one notch arranged at the inner circumference of the filter bellows.

13. The filter element according to claim 1, wherein the at least one notch includes two or more notches disposed at the outer circumference and/or at the inner circumference of the filter bellows and spaced apart in the circumferential direction, wherein the at least one circumferential seal contour in a region of the two or more notches comprises one of the at least one locally limited protrusion or recess provided for each one of the two or more notches and arranged in the circumferential direction such that a circumferential position thereof corresponds to a circumferential position of the two or more notches, respectively.

14. The filter element according to claim 13, wherein the two or more notches include a first notch arranged at the inner circumference of the filter bellows and a second notch arranged at the outer circumference of the filter bellows.

15. The filter element according to claim 13, wherein the first end plate comprises at least two cuts corresponding respectively to the two or more notches of the filter bellows and each one aligned with one of the two or more notches, respectively.

16. The filter element according to claim 1, wherein the at least one circumferential seal contour comprises at least one circumferential radial seal surface.

17. The filter element according to claim 16, wherein the at least one circumferential radial seal surface is arranged at an inner circumference of the at least one circumferential seal contour.

18. A filter device comprising:
a filter housing comprising a fluid inlet and a fluid outlet and further comprising a receiving space configured to receive the filter element according to claim 1, wherein the filter element is arranged in the receiving space such that the filter element separates a raw side correlated with the fluid inlet from a clean side correlated with the fluid outlet.

19. The filter device according to claim 18, wherein the filter housing comprises at least one circumferential housing seal surface, wherein the at least one circumferential seal contour of the filter element rests against the at least one circumferential housing seal surface, wherein the at least one housing seal surface comprises at least one locally limited protrusion or recess corresponding to the at least one locally limited protrusion or recess of the at least one circumferential seal contour of the filter element.

20. The filter device according to claim 18, wherein the filter housing comprises at least one housing projection projecting into the receiving space, and wherein the at least one housing projection is received in the at least one notch of the filter bellows of the filter element.
